(19) United States
(12) Patent Application Publication
(10) Pub. No.: US 2026/0187225 A1
(43) Pub. Date: Jul. 2, 2026

(54) METHOD AND ELECTRONIC DEVICE FOR PERFORMING MUTUAL AUTHENTICATION FOR INTERCONNECT SECURITY

(71) Applicant: REBELLIONS INC., Seongnam-si (KR)

(72) Inventor: Myunghoon CHOI, Seongnam-si (KR)

(21) Appl. No.: 19/438,458

(22) Filed: Dec. 31, 2025

(30) Foreign Application Priority Data
Jan. 2, 2025 (KR) 10-2025-0000169

(51) Int. Cl. G06F 21/44; G06F 21/53; G06F 21/85

(52) U.S. Cl. CPC G06F 21/445; G06F 21/53; G06F 21/85; G06F 2221/034

(57) ABSTRACT

The present disclosure relates to an electronic device. The electronic device includes an immutable memory and a security processor, and the security processor may be configured to: if first authentication for the electronic device is successful by a host device connected through an interface, obtain first authentication information of the host device from the host device using a security protocol, register the first authentication information in the immutable memory, perform second authentication for the host device based on the registered first authentication information, create a first secure session using the security protocol if the second authentication is successful, and perform a first configuration for security of the interface through the first secure session.

### CROSS-REFERENCE TO RELATED APPLICATION

This application claims priority to Korean Patent Application No. 10-2025-0000169, filed in the Korean Intellectual Property Office on Jan. 2, 2025, the entire contents of which are hereby incorporated by reference.

### BACKGROUND

### Field

Aspects of some embodiments relate to a method and an electronic device for performing mutual authentication for interconnect security.

### Description of Related Art

With the development of communication technology, interconnection between electronic devices is becoming easier, and operations such as data exchange or collaboration through interconnection are becoming easier. However, in the case of a system where a plurality of electronic devices are connected, such as a host device, if at least one malicious device exists among the plurality of connected electronic devices, the security of the entire system may be threatened.

Accordingly, it is desirable to develop a technology for mutual authentication in which a host device performs authentication for an electronic device connected to the host device, as well as the electronic device connected to the host device performing authentication for the host device.

### SUMMARY

The present disclosure provides a method and an electronic device for performing mutual authentication for interconnect security to solve the problems as described above.

The present disclosure may be implemented in various ways, including a method, a device (system), and/or a computer program stored in a computer-readable storage medium.

According to an embodiment of the present disclosure, an electronic device may be configured to include an immutable memory and a security processor, and the security processor may be configured to: obtain first authentication information of a host device from the host device using a security protocol if first authentication for the electronic device is successful by the host device connected through an interface; register the first authentication information in the immutable memory; perform second authentication for the host device based on the registered first authentication information; create a first secure session using the security protocol if the second authentication is successful; and perform a first configuration for security of the interface through the first secure session.

According to an embodiment, the security processor may be configured to: obtain reference information including a configuration related to security of the host device from the host device using the security protocol; register the reference information in the immutable memory; and verify a security state of the host device based on the registered reference information.

According to an embodiment, the security processor may be configured to: if second authentication information of the host device is obtained from the host device using the security protocol, perform third authentication for the host device associated with the second authentication information based on the registered first authentication information; register the second authentication information in the immutable memory if the third authentication is successful; create a second secure session using the security protocol; and perform a second configuration for security of the interface through the second secure session.

According to an embodiment, the security processor may be configured to: if third authentication information of the host device is obtained from the host device using the security protocol, perform fourth authentication for the host device associated with the third authentication information based on the registered first authentication information or the registered second authentication information; register the third authentication information in the immutable memory if the fourth authentication is successful; create a third secure session using the security protocol; and perform a third configuration for security of the interface through the third secure session.

According to an embodiment, the security processor may be configured to: if a signal requesting revocation of the second authentication information is received from the host device using the security protocol, perform fourth authentication for the host device associated with the second authentication information based on the registered first authentication information; and revoke the second authentication information from the immutable memory if the fourth authentication is successful.

According to an embodiment, the immutable memory may include a plurality of slots for registering authentication information, a first field indicating whether authentication information is in a registered state in each of the plurality of slots, and a second field indicating whether authentication information registered in each of the plurality of slots is in a revoked state.

According to an embodiment, the second authentication information may include authentication information associated with a trusted execution environment virtual machine (TEE VM) generated by the host device.

According to an embodiment, the security processor may be configured to: store mapping information of the first authentication information and information associated with the first configuration in a volatile memory accessible by the security processor; and restrict a change of the information associated with the first configuration through other authentication information of the host device based on the mapping information.

According to an embodiment, the security protocol may include a protocol based on SPDM.

According to an embodiment, the interface may include a peripheral component interconnect express (PCIe) interface, and the first configuration may include a configuration associated with at least one of integrity and data encryption (IDE) or TEE device interface security protocol (TDISP).

According to an embodiment of the present disclosure, a method for performing mutual authentication, performed by a security processor of an electronic device, may include: obtaining first authentication information of a host device from the host device using a security protocol if first authentication for the electronic device is successful by the host device connected through an interface; registering the first authentication information in an immutable memory of the electronic device; performing second authentication for the host device based on the registered first authentication information; creating a first secure session using the security protocol if the second authentication is successful; and performing a first configuration for security of the interface through the first secure session.

According to an embodiment, the method for performing mutual authentication may further include: obtaining reference information including a configuration related to security of the host device from the host device using the security protocol; registering the reference information in the immutable memory; and verifying a security state of the host device based on the registered reference information.

According to an embodiment, the method for performing mutual authentication may further include: if second authentication information of the host device is obtained from the host device using the security protocol, performing third authentication for the host device associated with the second authentication information based on the registered first authentication information; registering the second authentication information in the immutable memory if the third authentication is successful; creating a second secure session using the security protocol; and performing a second configuration for security of the interface through the second secure session.

According to an embodiment, the method for performing mutual authentication may further include: if third authentication information of the host device is obtained from the host device using the security protocol, performing fourth authentication for the host device associated with the third authentication information based on the registered first authentication information or the registered second authentication information; registering the third authentication information in the immutable memory if the fourth authentication is successful; creating a third secure session using the security protocol; and performing a third configuration for security of the interface through the third secure session.

According to an embodiment, the method for performing mutual authentication may further include: if a signal requesting revocation of the second authentication information is received from the host device using the security protocol, performing fourth authentication for the host device associated with the second authentication information based on the registered first authentication information; and revoking the second authentication information from the immutable memory if the fourth authentication is successful.

According to an embodiment, the method for performing mutual authentication may further include: storing mapping information of the first authentication information and information associated with the first configuration in a volatile memory accessible by the security processor; and restricting a change of the information associated with the first configuration through other authentication information of the host device based on the mapping information.

According to some embodiments of the present disclosure, the host device performs authentication for the electronic device connected to the host device, and the electronic device connected to the host device also performs authentication for the host device, whereby security for interconnection may be increased.

Effects of the present disclosure are not limited to the effects mentioned above, and other effects not mentioned will be clearly understood by those of ordinary skill in the art to which the present disclosure pertains (referred to as a “person of ordinary skill in the art”) from the description of the claims.

### BRIEF DESCRIPTION OF THE DRAWINGS

Embodiments of the present disclosure will be described with reference to the accompanying drawings described below, where like reference numerals indicate like elements, but are not limited thereto.

FIG. 1 illustrates a system for performing mutual authentication for interconnect security according to an embodiment of the present disclosure.

FIG. 2 illustrates an immutable memory of an electronic device connected to a host device according to an embodiment of the present disclosure.

FIG. 3 illustrates a state in which authentication information of a host device is registered in an immutable memory according to an embodiment of the present disclosure.

FIG. 4 illustrates a state in which other authentication information of the host device is registered in the immutable memory according to an embodiment of the present disclosure.

FIG. 5 illustrates a state in which another authentication information of the host device is registered in the immutable memory according to an embodiment of the present disclosure.

FIG. 6 illustrates a state in which authentication information of the host device registered in the immutable memory is revoked according to an embodiment of the present disclosure.

FIG. 7 illustrates a method for performing mutual authentication for interconnect security according to an embodiment of the present disclosure.

FIG. 8 illustrates a method for verifying a security state of a host device according to an embodiment of the present disclosure.

FIG. 9 illustrates a method for performing mutual authentication using other authentication information of a host device according to an embodiment of the present disclosure.

FIG. 10 illustrates a method for performing mutual authentication using another authentication information of a host device according to an embodiment of the present disclosure.

FIG. 11 illustrates a method for revoking authentication information of a host device registered in an immutable memory according to an embodiment of the present disclosure.

FIG. 12 illustrates a method for restricting a change of information associated with a configuration through other authentication information of a host device based on mapping information of authentication information of the host device and information associated with a configuration for security of an interface based on the authentication information according to an embodiment of the present disclosure.

### DETAILED DESCRIPTION

Hereinafter, specific details for the practice of the present disclosure will be described in detail with reference to the accompanying drawings. However, in the following description, detailed descriptions of well-known functions or configurations will be omitted if there is a concern that they may unnecessarily obscure the subject matter of the present disclosure.

In the accompanying drawings, the same or corresponding components are given the same reference numerals. In addition, in the description of the following embodiments, redundant description of the same or corresponding components may be omitted. However, even if the description of a component is omitted, it is not intended that such a component is not included in an embodiment.

Advantages and features of the disclosed embodiments and methods for achieving them will become clear with reference to the embodiments described below in conjunction with the accompanying drawings. However, the present disclosure is not limited to the embodiments disclosed below but may be implemented in various different forms; the present embodiments are merely provided to complete the present disclosure and to fully inform a person of ordinary skill in the art of the scope of the invention.

Terms used in the present specification will be briefly described, and the disclosed embodiments will be described in detail. The terms used in the present specification have been selected from general terms currently widely used as much as possible while considering functions in the present disclosure, but this may vary according to the intention of a technician engaged in the relevant field, precedents, or the emergence of new technologies. In addition, in specific cases, there are terms arbitrarily selected by the applicant, and in this case, the meaning will be described in detail in the corresponding part of the description of the invention. Therefore, the terms used in the present disclosure should be defined based on the meaning of the term and the contents throughout the present disclosure, not just the name of the term.

Singular expressions in the present specification include plural expressions unless the context clearly specifies otherwise as singular. In addition, plural expressions include singular expressions unless the context clearly specifies otherwise as plural. Throughout the specification, if a part is said to “include” a certain component, this means that it may further include other components rather than excluding other components unless specifically stated otherwise.

In addition, the term ‘module’ or ‘unit’ used in the specification means a software or hardware component, and the ‘module’ or ‘unit’ performs certain roles. However, ‘module’ or ‘unit’ is not limited to software or hardware. A ‘module’ or ‘unit’ may be configured to be in an addressable storage medium or may be configured to reproduce one or more processors. Thus, as an example, a ‘module’ or ‘unit’ may include components such as software components, object-oriented software components, class components, and task components, and at least one of processes, functions, attributes, procedures, subroutines, segments of program code, drivers, firmware, microcode, circuits, data, databases, data structures, tables, arrays, or variables. The functions provided within the components and ‘modules’ or ‘units’ may be combined into a smaller number of components and ‘modules’ or ‘units’ or further separated into additional components and ‘modules’or ‘units’.

According to an embodiment of the present disclosure, a ‘module’ or ‘unit’ may be implemented with a processor and a memory. A ‘processor’ should be interpreted broadly to include a general-purpose processor, a central processing unit (CPU), a microprocessor, a digital signal processor (DSP), a controller, a microcontroller, a state machine, and the like. In some environments, a ‘processor’ may also refer to an application-specific integrated circuit (ASIC), a programmable logic device (PLD), a field-programmable gate array (FPGA), and the like. A ‘processor’ may refer to a combination of processing devices, such as a combination of a DSP and a microprocessor, a combination of a plurality of microprocessors, a combination of one or more microprocessors combined with a DSP core, or any other such combination of configurations. In addition, a ‘memory’ should be interpreted broadly to include any electronic component capable of storing electronic information. A ‘memory’ may also refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage devices, registers, and the like. A memory is said to be in electronic communication with a processor if the processor can read information from the memory and/or write information to the memory. A memory integrated into a processor is in electronic communication with the processor.

In addition, terms such as first, second, A, B, (a), and (b) used in the following embodiments are only used to distinguish a component from another component, and the essence, order, or sequence of the corresponding component is not limited by the terms.

In addition, in the following embodiments, if it is described that a component is ‘connected’, ‘coupled’, or ‘joined’ to another component, the component may be directly connected or joined to the other component, but it should be understood that another component may be ‘connected’, ‘coupled’, or ‘joined’between each component.

In addition, ‘comprises’ and/or ‘comprising’ used in the following embodiments do not exclude the presence or addition of one or more other components, steps, operations, and/or elements.

Hereinafter, various embodiments of the present disclosure will be described in detail according to the accompanying drawings.

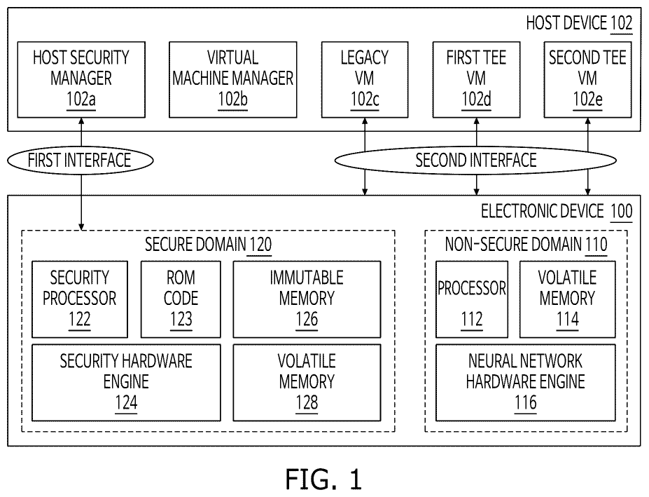

FIG. 1 illustrates a system for performing mutual authentication for interconnect security according to an embodiment of the present disclosure. Referring to FIG. 1, an electronic device 100 may be connected to a host device 102 through an interface for communication with the host device 102 (e.g., a second interface of FIG. 1) (hereinafter, referred to as the second interface). According to an embodiment, the second interface may include a peripheral component interconnect express (PCIe) interface.

The interconnected host device 102 may include a host security manager 102a, a virtual machine manager 102b, a legacy virtual machine (legacy VM) 102c, a first trusted execution environment virtual machine (first TEE VM) 102d, and a second TEE VM 102e. However, the configuration of the host device 102 is not limited thereto. According to various embodiments, the host device 102 may omit at least one of the components described above and may further include at least one other component.

The host security manager 102a may be responsible for the security of the host device 102. For example, the host security manager 102a may perform authentication management, data encryption, encryption key management, access right management, security policy management, communication security, data integrity verification, software and firmware integrity verification, and the like. Accordingly, the host security manager 102a may be the most trusted root in the host device 102.

The virtual machine manager 102b may manage hardware resources of the host device 102 and support the execution of a plurality of virtual machines (e.g., the legacy VM 102c, the first TEE VM 102d, the second TEE VM 102e, etc.) in a virtual environment. For example, the virtual machine manager 102b may perform virtualization and management of hardware resources, management of creation and deletion of VMs, isolation between VMs, operating system support, management of communication between the host device 102 and the VMs, and the like.

The legacy VM 102c is a VM that focuses on compatibility and general virtualization tasks rather than security, and may represent a VM used to execute legacy software or operating systems.

A TEE VM (e.g., the first TEE VM 102d or the second TEE VM 102e) is a VM used to process applications or data where security and trust are important, and may perform processing of security-sensitive data, provision of a trusted execution environment, execution of security applications, management of encryption keys and authentication, security authentication, integrity verification, etc.

The electronic device 100 may be divided into a non-secure domain 110 (or a general domain) and a secure domain 120. The non-secure domain 110 may include a processor 112 (or a normal core), a volatile memory 114, and a neural network hardware engine 116. However, the configuration included in the non-secure domain 110 is not limited thereto. According to various embodiments, the non-secure domain 110 may omit at least one of the components described above and may further include at least one other component. In addition, the secure domain 120 may include a security processor 122 (or a security core), read-only memory (ROM) code 123, a security hardware engine 124, an immutable memory 126, and a volatile memory 128. However, the configuration included in the secure domain 120 is not limited thereto. According to various embodiments, the secure domain 120 may omit at least one of the components described above and may further include at least one other component. Since the secure domain 120 is an area where security-related tasks are performed, other configurations inside/outside the system except for the security processor 122 can access the security processor 122 only for limited purposes such as sending access requests for encrypted data, and access to the secure domain 120 except for this may be restricted. Accordingly, the secure domain 120 may be the most trusted root in the electronic device 100.

The processor 112 may be a core that performs computational tasks. Additionally or alternatively, the processor 112 may be a core that manages cores performing computational tasks or distributes tasks. For example, the processor 112 may load data stored in the volatile memory 114 to process (e.g., calculate) or drive the data. However, the type or function of the processor 112 is not limited thereto.

The volatile memory 114 may include a memory for storing and/or processing data and/or software during operation of the processor 112 and the security processor 122. That is, data in use may be stored in the volatile memory 114. For example, data used for artificial intelligence (AI) operations may be stored in the volatile memory 114. According to an embodiment, the volatile memory 114 may include at least one of static RAM (SRAM) or dynamic RAM (DRAM).

The neural network hardware engine 116 may be dedicated hardware designed to accelerate AI and machine learning (ML) tasks, particularly the operation of neural network models. According to an embodiment, the neural network hardware engine 116 may include a neural processing unit (NPU).

The security processor 122 may be a core that performs computational tasks for security purposes. Additionally or alternatively, the security processor 122 may be a core that manages cores performing computational tasks for security purposes or distributes tasks. For example, the security processor 122 may perform integrity verification for at least some data stored in the volatile memory 114 periodically or non-periodically. In addition, since the security processor 122 must be able to stop all operations of the system except for the security processor 122 if a security-related problem (e.g., integrity verification failure) occurs, the security processor 122 may have the highest priority among the cores of the electronic device 100. Under such a configuration, the security processor 122 may be accessible to all configurations of the electronic device 100. According to an embodiment, if the security processor 122 accesses the volatile memory 114, the security processor 122 may use a direct memory access (DMA) dedicated to the security processor 122 to accelerate data traffic.

The ROM code 123 may represent program code or data stored in the ROM. According to an embodiment, the ROM code 123 may include a first stage bootloader.

The security hardware engine 124 may be a dedicated hardware module that accelerates and protects security tasks at the hardware level. Such a security hardware engine 124 may be used to process sensitive data or cryptographic operations. For example, the security hardware engine 124 may perform encryption and decryption, digital signature and authentication, key management and storage, random number generation, access control, and the like.

The immutable memory 126 may store security information (e.g., an encryption key or secure firmware), and only the security processor 122 existing inside the secure domain 120 may be able to access the immutable memory 126. According to an embodiment, the immutable memory 126 may include a one-time programmable (OTP) memory.

The volatile memory 128 is a memory included in the secure domain 120, and may temporarily store important data while security-related tasks are being processed. According to an embodiment, the volatile memory 128 may include SRAM.

Looking at the process of performing mutual authentication, if authentication for the electronic device 100 is successful by the host device 102 connected through the second interface, the security processor 122 may obtain authentication information (hereinafter, referred to as first authentication information) of the host device 102 from the host device 102 using a security protocol. Here, the security protocol may represent a message exchange method on the first interface. According to an embodiment, the security protocol may include a protocol based on security protocol and data model (SPDM). In addition, the first interface may include a PCIe interface or a system management bus (SMbus).

Then, the security processor 122 may register the first authentication information in the immutable memory 126. Here, the immutable memory 126 may include a plurality of slots for registering authentication information, a first field indicating whether authentication information is in a registered state in each of the plurality of slots, and a second field indicating whether authentication information registered in each of the plurality of slots is in a revoked state.

Then, the security processor 122 may perform authentication for the host device 102 based on the registered first authentication information.

Then, if authentication for the host device 102 is successful, the security processor 122 may create a secure session (hereinafter, referred to as a first secure session) using the security protocol. For example, if authentication for the electronic device 100 is successful and authentication for the host device 102 is successful, mutual authentication may be completed, and if mutual authentication is completed, the security processor 122 may create the first secure session.

Then, the security processor 122 may perform a configuration for security of the second interface (hereinafter, referred to as a first configuration) through the first secure session. Here, the second interface includes a PCIe interface, and the first configuration may include a configuration associated with at least one of integrity and data encryption (IDE) or TEE device interface security protocol (TDISP). IDE represents a function that provides data integrity and data encryption, and may be used to maintain security if data is transmitted or stored, to protect important information, to prevent modification, and to block unauthorized access. TDISP represents a security protocol for safe communication between the TEE and an external device, and can guarantee data encryption, integrity verification, authentication, and confidentiality.

According to an embodiment, the security processor 122 may obtain reference information including a configuration related to security of the host device 102 from the host device 102 using the security protocol. Here, the reference information may include a measurement reference value. In addition, the security processor 122 may register the reference information in the immutable memory 126. Then, the security processor 122 may verify a security state of the host device 102 based on the registered reference information.

According to an embodiment, if other authentication information (hereinafter, referred to as second authentication information) of the host device 102 is obtained from the host device 102 using the security protocol, the security processor 122 may perform authentication for the host device 102 associated with the second authentication information based on the already registered first authentication information. Here, the second authentication information may include authentication information associated with a TEE VM (e.g., the first TEE VM 102d) generated by the host device 102. Then, if authentication for the host device 102 associated with the second authentication information is successful, the security processor 122 may register the second authentication information in the immutable memory 126. Then, the security processor 122 may create another secure session (hereinafter, referred to as a second secure session) using the security protocol, and perform another configuration for security of the second interface (hereinafter, referred to as a second configuration) through the second secure session.

According to an embodiment, if another authentication information (hereinafter, referred to as third authentication information) of the host device 102 is obtained from the host device 102 using the security protocol, the security processor 122 may perform authentication for the host device 102 associated with the third authentication information based on the already registered first authentication information or the already registered second authentication information. Here, the third authentication information may include authentication information associated with another TEE VM (e.g., the second TEE VM 102e) generated by the host device 102. Then, if authentication for the host device 102 associated with the third authentication information is successful, the security processor 122 may register the third authentication information in the immutable memory 126. Then, the security processor 122 may create another secure session (hereinafter, referred to as a third secure session) using the security protocol, and perform another configuration for security of the second interface (hereinafter, referred to as a third configuration) through the third secure session.

According to an embodiment, if a signal requesting revocation of authentication information (e.g., the second authentication information) registered in the immutable memory 126 is received from the host device 102 using the security protocol, the security processor 122 may perform authentication for the host device 102 associated with the authentication information for which revocation was requested based on other already registered authentication information (e.g., the first authentication information). Then, if authentication for the host device 102 associated with the authentication information for which revocation was requested is successful, the security processor 122 may revoke the authentication information for which revocation was requested from the immutable memory 126. Here, revocation in the immutable memory 126 may refer to restricting access to the data so that the data is not used, rather than deleting data due to characteristics of the immutable memory 126.

According to an embodiment, the security processor 122 may store mapping information of authentication information and information associated with a configuration corresponding to the authentication information in the volatile memory 128 accessible by the security processor 122. For example, the security processor 122 may map the first authentication information and information associated with the first configuration, map the second authentication information and information associated with the second configuration, and map the third authentication information and information associated with the third configuration. That is, the mapping information may be mapping information of (n)-th authentication information and information associated with an (n)-th configuration. Here, n may be a natural number. Then, the security processor 122 may restrict a change of the information associated with the configuration through other authentication information of the host device 102 based on the mapping information stored in the volatile memory 128. For example, if the first authentication information and the information associated with the first configuration are mapped, if the TEE VM attempts to change the information associated with the first configuration through the second authentication information, the security processor 122 may control so that the corresponding change is not performed.

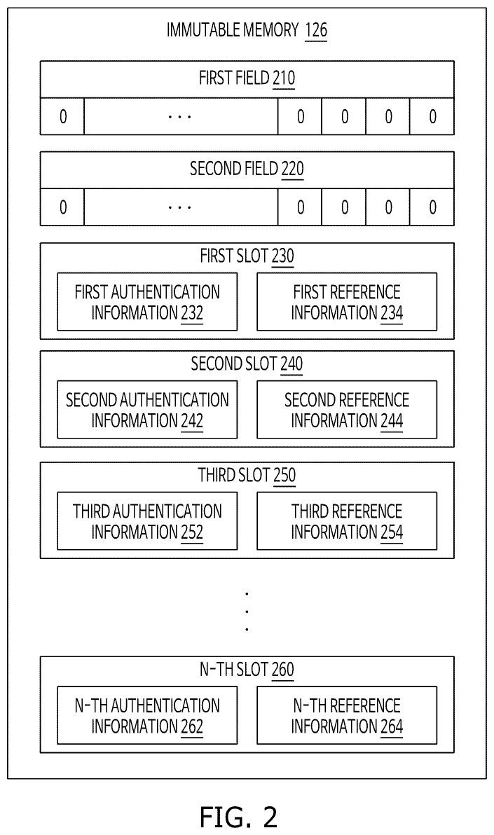

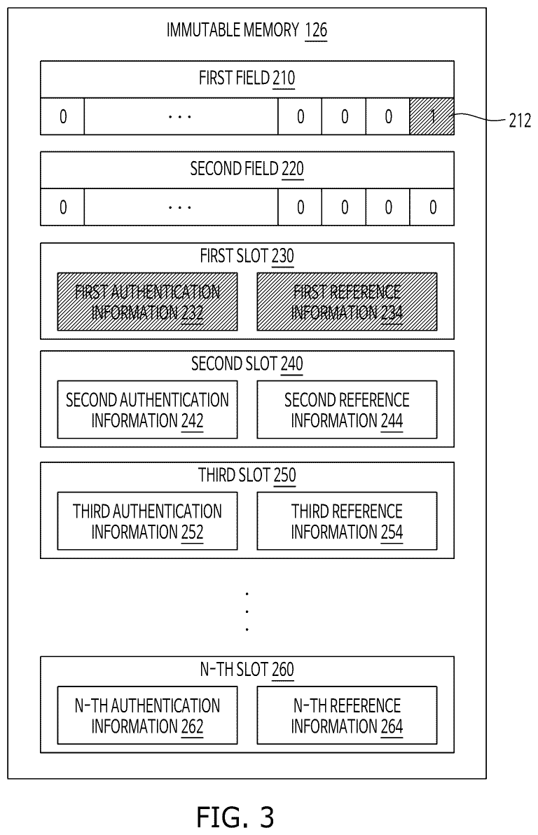

FIG. 2 illustrates the immutable memory 126 of the electronic device connected to the host device according to an embodiment of the present disclosure. Referring to FIG. 2, the immutable memory 126 may include a plurality of slots (e.g., a first slot 230, a second slot 240, a third slot 250, . . . , an (n)-th slot 260, where n is a natural number greater than or equal to 4) for registering authentication information, a first field 210 indicating whether authentication information is in a registered state in each of the plurality of slots, and a second field 220 indicating whether authentication information registered in each of the plurality of slots is in a revoked state. The first field 210 and the second field 220 are for indicating validity of each of the plurality of slots, and an initial value may be a first value (e.g., ‘0 (zero)’). Then, if authentication information 232, 242, 252, 262 of a host device (e.g., the host device 102 of FIG. 1) is registered in at least one slot among the plurality of slots, a corresponding field value of the first field 210 may be changed to a second value (e.g., ‘1’). Then, if the authentication information 232, 242, 252, 262 registered in at least one slot among the plurality of slots is revoked, a corresponding field value of the second field 220 may be changed to a third value (e.g., ‘1’). State changes of the immutable memory 126 according to registration and revocation of the authentication information described above will be described in detail with reference to FIGS. 3 to 6.

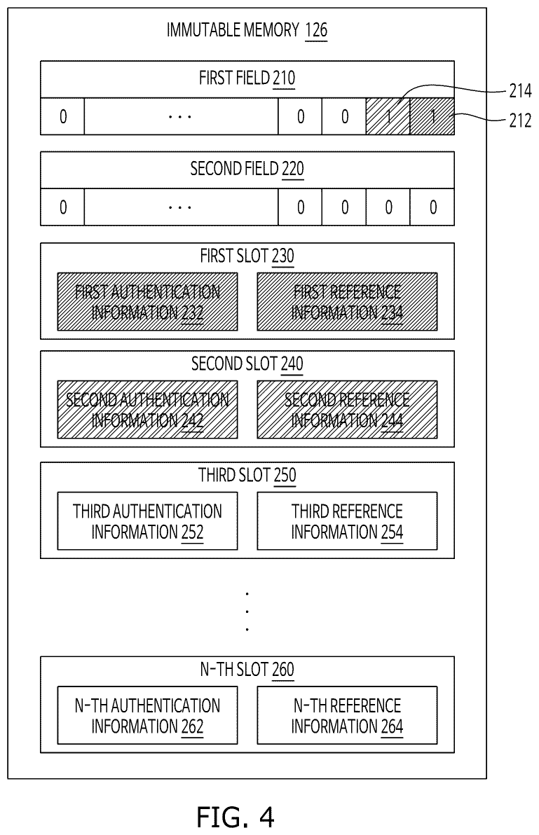

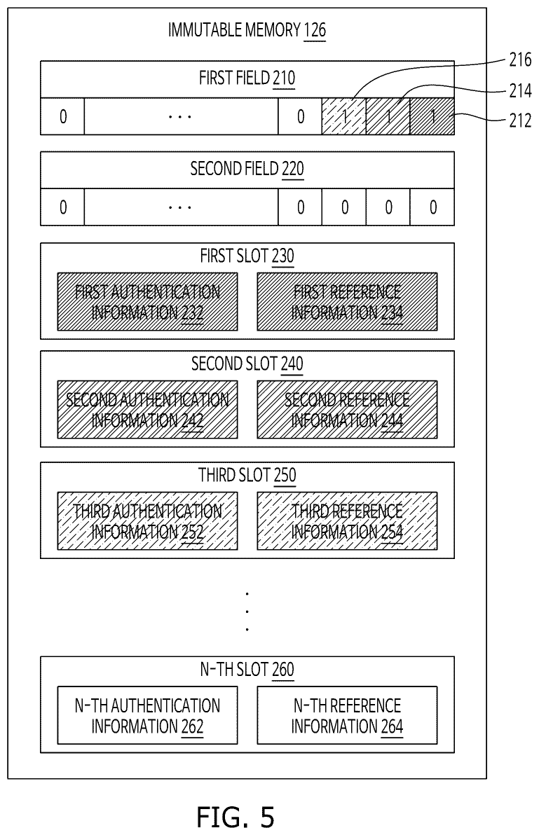

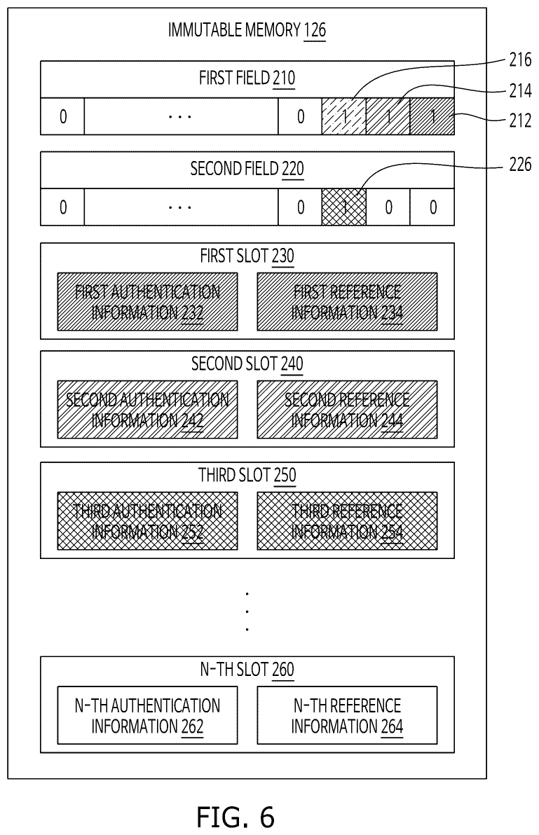

FIG. 3 is a diagram illustrating a state in which authentication information of a host device is registered in an immutable memory according to an embodiment of the present disclosure, FIG. 4 is a diagram illustrating a state in which other authentication information of the host device is registered in the immutable memory according to an embodiment of the present disclosure, FIG. 5 is a diagram illustrating a state in which another authentication information of the host device is registered in the immutable memory according to an embodiment of the present disclosure, and FIG. 6 is a diagram illustrating a state in which authentication information of the host device registered in the immutable memory is revoked according to an embodiment of the present disclosure. Referring to FIGS. 3 to 6, a security processor (e.g., the security processor 122 of FIG. 1) of an electronic device (e.g., the electronic device 100 of FIG. 1) may obtain authentication information (hereinafter, referred to as first authentication information) 232 of a host device from the host device using a security protocol if authentication for the electronic device is successful by the host device (e.g., the host device 102 of FIG. 1) connected through an interface. Here, the security protocol may include a protocol based on SPDM. Then, as shown in FIG. 3, the security processor may register the first authentication information 232 in the immutable memory 126. For example, the security processor may register the first authentication information 232 in an empty slot (e.g., the first slot 230) among the plurality of slots 230, 240, 250, 260. In addition, the security processor may change a field value 212 corresponding to the slot in which the first authentication information 232 is registered among the field values of the first field 210 from a first value (e.g., ‘0’) to a second value (e.g., ‘1’). In addition, if the security processor obtains reference information (hereinafter, referred to as first reference information) 234 (e.g., a measurement reference value) including a configuration related to security of the host device from the host device using the security protocol, the security processor may register the first reference information 234 in the slot in which the first authentication information 232 is registered.

Then, if the security processor obtains other authentication information (hereinafter, referred to as second authentication information) 242 of the host device from the host device using the security protocol, the security processor may perform authentication for the host device associated with the second authentication information 242 based on the already registered first authentication information 232. Here, the second authentication information 242 may include authentication information associated with a TEE VM (e.g., the first TEE VM 102d of FIG. 1) generated by the host device. Then, if authentication for the host device associated with the second authentication information 242 is successful, as shown in FIG. 4, the security processor may register the second authentication information 242 in the immutable memory 126. For example, the security processor may register the second authentication information 242 in an empty slot (e.g., the second slot 240) among the plurality of slots 230, 240, 250, 260. In addition, the security processor may change a field value 214 corresponding to the slot in which the second authentication information 242 is registered among the field values of the first field 210 from the first value (e.g., ‘0’) to the second value (e.g., ‘1’). In addition, if the security processor obtains reference information (hereinafter, referred to as second reference information) 244 including another configuration related to security of the host device from the host device using the security protocol, the security processor may register the second reference information 244 in the slot in which the second authentication information 242 is registered.

Then, if the security processor obtains another authentication information (hereinafter, referred to as third authentication information) 252 of the host device from the host device using the security protocol, the security processor may perform authentication for the host device associated with the third authentication information 252 based on already registered authentication information (e.g., the first authentication information 232 or the second authentication information 242). Here, the third authentication information 252 may include authentication information associated with a TEE VM (e.g., the second TEE VM 102e of FIG. 1) generated by the host device. Then, if authentication for the host device associated with the third authentication information 252 is successful, as shown in FIG. 5, the security processor may register the third authentication information 252 in the immutable memory 126. For example, the security processor may register the third authentication information 252 in an empty slot (e.g., the third slot 250) among the plurality of slots 230, 240, 250, 260. In addition, the security processor may change a field value 216 corresponding to the slot in which the third authentication information 252 is registered among the field values of the first field 210 from the first value (e.g., ‘0’) to the second value (e.g., ‘1’). In addition, if the security processor obtains reference information (hereinafter, referred to as third reference information) 254 including another configuration related to security of the host device from the host device using the security protocol, the security processor may register the third reference information 254 in the slot in which the third authentication information 252 is registered.

Similarly, if the security processor obtains additional authentication information (hereinafter, referred to as (n)-th authentication information, where n is a natural number greater than or equal to 4) 262 of the host device from the host device using the security protocol, the security processor may perform authentication for the host device associated with the (n)-th authentication information 262 based on already registered authentication information (e.g., the first authentication information 232, the second authentication information 242, or the third authentication information 252). Then, if authentication for the host device associated with the (n)-th authentication information 262 is successful, the security processor may register the (n)-th authentication information 262 in the immutable memory 126. For example, the security processor may register the (n)-th authentication information 262 in an empty slot (e.g., the (n)-th slot 260) among the plurality of slots 230, 240, 250, 260. In addition, the security processor may change a field value corresponding to the slot in which the (n)-th authentication information 262 is registered among the field values of the first field 210 from the first value (e.g., ‘0’) to the second value (e.g., ‘1’). In addition, if the security processor obtains reference information (hereinafter, referred to as (n)-th reference information) 264 including an additional configuration related to security of the host device from the host device using the security protocol, the security processor may register the (n)-th reference information 264 in the slot in which the (n)-th authentication information 262 is registered.

Then, if the security processor receives a signal requesting revocation of authentication information (e.g., the third authentication information 252) registered in the immutable memory 126 from the host device using the security protocol, the security processor may perform authentication for the host device associated with the authentication information for which revocation was requested based on other already registered authentication information (e.g., the first authentication information 232 or the second authentication information 242). Then, if authentication for the host device associated with the authentication information for which revocation was requested is successful, the security processor may revoke the authentication information for which revocation was requested from the immutable memory 126, as shown in FIG. 6. For example, the security processor may change a field value 226 corresponding to the slot in which the authentication information for which revocation was requested is registered among the field values of the second field 220 from the first value (e.g., ‘0’) to the third value (e.g., ‘1’).

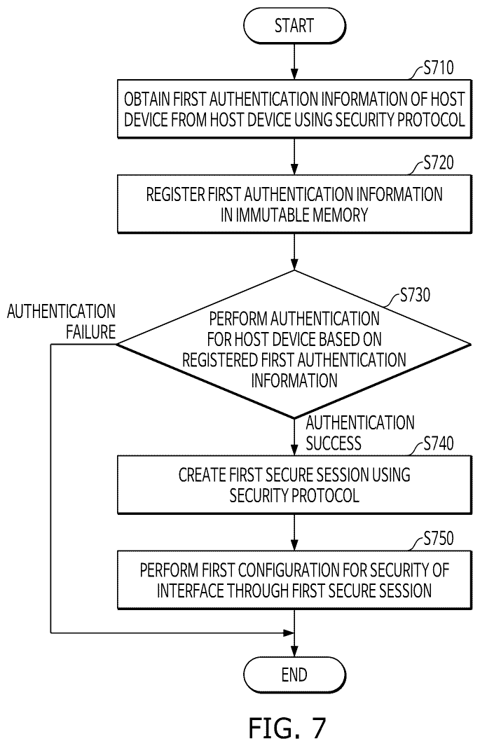

FIG. 7 illustrates a method for performing mutual authentication for interconnect security according to an embodiment of the present disclosure. Referring to FIG. 7, in step S710, a security processor (e.g., the security processor 122 of FIG. 1) of an electronic device (e.g., the electronic device 100 of FIG. 1) may obtain first authentication information from a host device (e.g., the host device 102 of FIG. 1) using a security protocol. For example, if authentication for the electronic device is successful by the host device connected through a second interface, the security processor may obtain the first authentication information of the host device from the host device using the security protocol. Here, the security protocol may represent a message exchange method on the first interface. According to an embodiment, the security protocol may include a protocol based on SPDM. In addition, the first interface may include a PCIe interface or SMbus.

In step S720, the security processor may register the first authentication information in an immutable memory (e.g., the immutable memory 126 of FIGS. 1 to 6). Here, the immutable memory may include a plurality of slots for registering authentication information, a first field indicating whether authentication information is in a registered state in each of the plurality of slots, and a second field indicating whether authentication information registered in each of the plurality of slots is in a revoked state. At this time, the security processor may register the first authentication information in an empty slot (e.g., a first slot) among the plurality of slots. In addition, the security processor may change a field value corresponding to the slot in which the first authentication information is registered among field values of the first field from a first value (e.g., ‘0’) to a second value (e.g., ‘1’).

In step S730, the security processor may perform authentication for the host device based on the registered first authentication information.

If authentication for the host device is successful, in step S740, the security processor may create a first secure session using the security protocol. If authentication for the host device fails, this method may be terminated.

In step S750, the security processor may perform a first configuration for security of the second interface through the first secure session. Here, the second interface includes a PCIe interface, and the first configuration may include a configuration associated with at least one of IDE or TDISP.

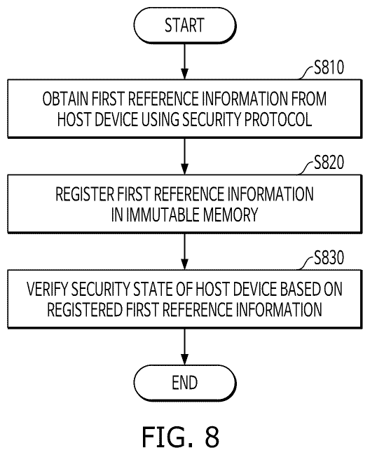

FIG. 8 illustrates a method for verifying a security state of a host device according to an embodiment of the present disclosure. Referring to FIG. 8, in step S810, a security processor (e.g., the security processor 122 of FIG. 1) of an electronic device (e.g., the electronic device 100 of FIG. 1) may obtain first reference information from a host device (e.g., the host device 102 of FIG. 1) using a security protocol. Here, the first reference information includes a configuration related to security of the host device, and may include, for example, a measurement reference value.

In step S820, the security processor may register the first reference information in an immutable memory (e.g., the immutable memory 126 of FIGS. 1 to 6). For example, the security processor may register the first reference information in a slot (e.g., a first slot) in which corresponding first authentication information is registered among slots included in the immutable memory.

In step S830, the security processor may verify a security state of the host device based on the registered first reference information.

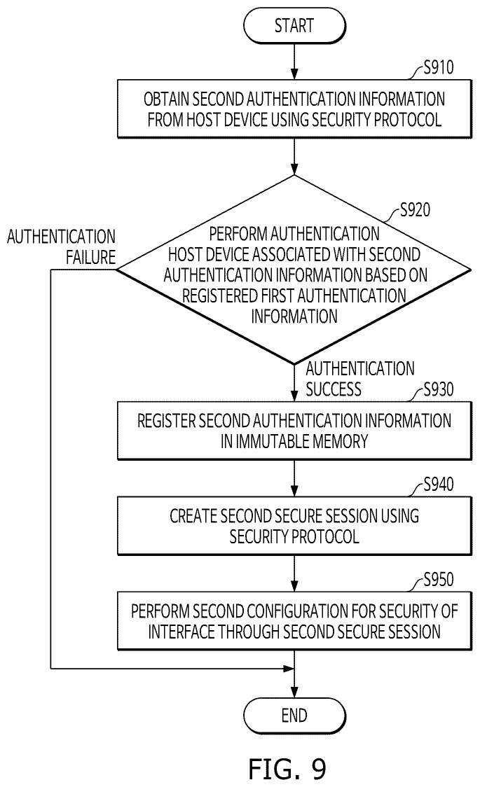

FIG. 9 illustrates a method for performing mutual authentication using other authentication information of a host device according to an embodiment of the present disclosure. Referring to FIG. 9, in step S910, a security processor (e.g., the security processor 122 of FIG. 1) of an electronic device (e.g., the electronic device 100 of FIG. 1) may obtain second authentication information from a host device (e.g., the host device 102 of FIG. 1) using a security protocol. For example, in a state where first authentication information of the host device is registered in an immutable memory (e.g., the immutable memory 126 of FIGS. 1 to 6), the security processor may obtain the second authentication information of the host device from the host device using the security protocol. Here, the security protocol may represent a message exchange method on the first interface. According to an embodiment, the security protocol may include a protocol based on SPDM. In addition, the first interface may include a PCIe interface or SMbus.

In step S920, the security processor may perform authentication for the host device associated with the second authentication information based on the registered first authentication information. For example, if the security processor obtains the second authentication information of the host device from the host device using the security protocol, the security processor may perform authentication for the host device associated with the second authentication information based on already registered first authentication information. Here, the second authentication information may include authentication information associated with a TEE VM (e.g., the first TEE VM 102d) generated by the host device.

If authentication for the host device associated with the second authentication information is successful, in step S930, the security processor may register the second authentication information in the immutable memory. For example, the security processor may register the second authentication information in an empty slot (e.g., a second slot) among a plurality of slots included in the immutable memory. In addition, the security processor may change a field value corresponding to the slot in which the second authentication information is registered among field values of a first field included in the immutable memory from a first value (e.g., ‘0’) to a second value (e.g., ‘1’). On the other hand, if authentication for the host device associated with the second authentication information fails, this method may be terminated.

In step S940, the security processor may create a second secure session using the security protocol.

In step S950, the security processor may perform a second configuration for security of the second interface through the second secure session. Here, the second interface includes a PCIe interface, and the second configuration may include a configuration associated with at least one of IDE or TDISP.

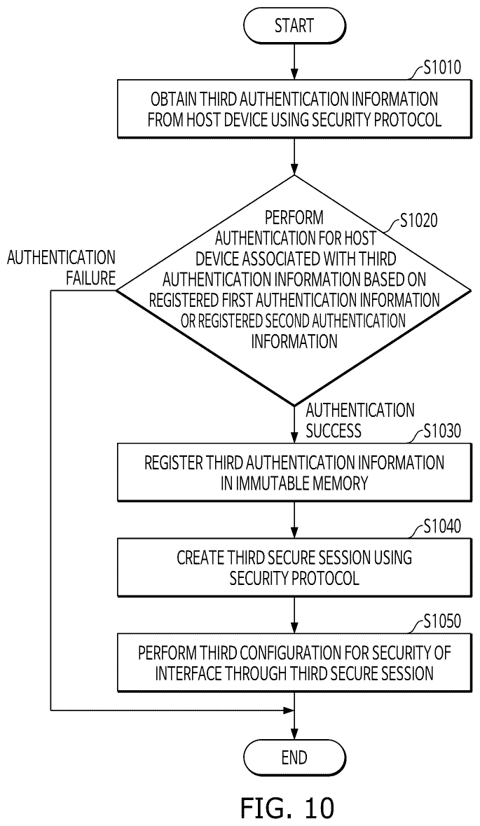

FIG. 10 illustrates a method for performing mutual authentication using another authentication information of a host device according to an embodiment of the present disclosure. Referring to FIG. 10, in step S1010, a security processor (e.g., the security processor 122 of FIG. 1) of an electronic device (e.g., the electronic device 100 of FIG. 1) may obtain third authentication information from a host device (e.g., the host device 102 of FIG. 1) using a security protocol. For example, in a state where first authentication information and second authentication information of the host device are registered in an immutable memory (e.g., the immutable memory 126 of FIGS. 1 to 6), the security processor may obtain the third authentication information of the host device from the host device using the security protocol. Here, the security protocol may represent a message exchange method on the first interface. According to an embodiment, the security protocol may include a protocol based on SPDM. In addition, the first interface may include a PCIe interface or SMbus.

In step S1020, the security processor may perform authentication for the host device associated with the third authentication information based on the registered first authentication information or second authentication information. For example, if the security processor obtains the third authentication information of the host device from the host device using the security protocol, the security processor may perform authentication for the host device associated with the third authentication information based on already registered authentication information (e.g., the first authentication information or the second authentication information). Here, the third authentication information may include authentication information associated with a TEE VM (e.g., the second TEE VM 102e) generated by the host device.

If authentication for the host device associated with the third authentication information is successful, in step S1030, the security processor may register the third authentication information in the immutable memory. For example, the security processor may register the third authentication information in an empty slot (e.g., a third slot) among a plurality of slots included in the immutable memory. In addition, the security processor may change a field value corresponding to the slot in which the third authentication information is registered among field values of a first field included in the immutable memory from a first value (e.g., ‘0’) to a second value (e.g., ‘1’). On the other hand, if authentication for the host device associated with the third authentication information fails, this method may be terminated.

In step S1040, the security processor may create a third secure session using the security protocol.

In step S1050, the security processor may perform a third configuration for security of the second interface through the third secure session. Here, the second interface includes a PCIe interface, and the third configuration may include a configuration associated with at least one of IDE or TDISP.

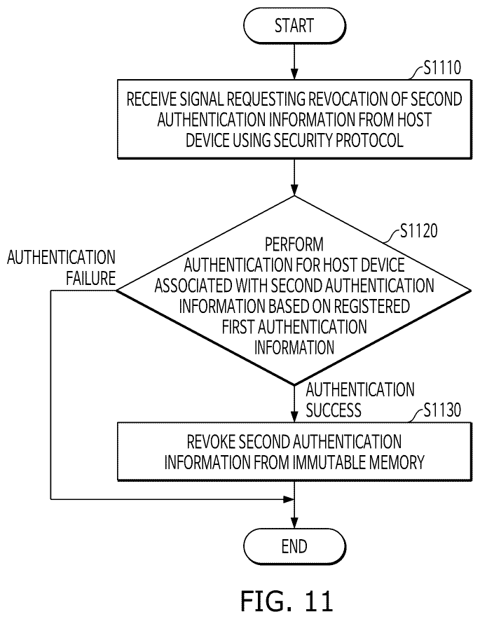

FIG. 11 illustrates a method for revoking authentication information of a host device registered in an immutable memory according to an embodiment of the present disclosure. Referring to FIG. 11, in step S1110, a security processor (e.g., the security processor 122 of FIG. 1) of an electronic device (e.g., the electronic device 100 of FIG. 1) may receive a signal requesting revocation of second authentication information from a host device (e.g., the host device 102 of FIG. 1) using a security protocol. For example, in a state where first authentication information and the second authentication information of the host device are registered in an immutable memory (e.g., the immutable memory 126 of FIGS. 1 to 6), the security processor may receive a signal requesting revocation of the second authentication information registered in the immutable memory from the host device using the security protocol. Here, the security protocol may represent a message exchange method on the first interface. According to an embodiment, the security protocol may include a protocol based on SPDM. In addition, the first interface may include a PCIe interface or SMbus.

In step S1120, the security processor may perform authentication for the host device associated with the second authentication information based on the registered first authentication information. For example, if the security processor receives a signal requesting revocation of the second authentication information registered in the immutable memory from the host device using the security protocol, the security processor may perform authentication for the host device associated with the second authentication information based on already registered other authentication information, that is, the first authentication information.

If authentication for the host device associated with the second authentication information is successful, in step S1130, the security processor may revoke the second authentication information from the immutable memory. For example, the security processor may change a field value corresponding to the slot in which the second authentication information is registered among field values of a second field included in the immutable memory from a first value (e.g., ‘0’) to a third value (e.g., ‘1’). On the other hand, if authentication for the host device associated with the second authentication information fails, this method may be terminated.

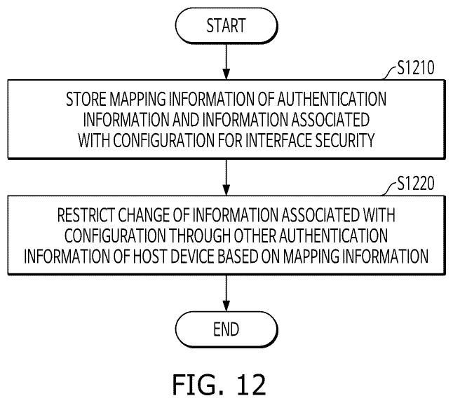

FIG. 12 illustrates a method for restricting a change of information associated with a configuration through other authentication information of a host device based on mapping information of authentication information and information associated with a configuration for security of an interface based on the authentication information according to an embodiment of the present disclosure. Referring to FIG. 12, in step S1210, a security processor (e.g., the security processor 122 of FIG. 1) of an electronic device (e.g., the electronic device 100 of FIG. 1) may store mapping information of authentication information and information associated with a configuration for security of an interface. For example, the security processor may map first authentication information and information associated with a first configuration, map second authentication information and information associated with a second configuration, and map third authentication information and information associated with a third configuration. That is, the mapping information may be mapping information of (n)-th authentication information and information associated with an (n)-th configuration. In addition, the security processor may store the mapping information in a volatile memory (e.g., the volatile memory 128 of FIG. 1) accessible by the security processor.

In step S1220, the security processor may restrict a change of the information associated with the configuration through other authentication information of a host device (e.g., the host device 102 of FIG. 1) based on the mapping information. For example, if the first authentication information and the information associated with the first configuration are mapped, if a TEE VM attempts to change the information associated with the first configuration through the second authentication information, the security processor may control so that the corresponding change is not performed.

The above-described flowcharts and description are merely examples, and may be implemented differently in some embodiments. For example, in some embodiments, the order of each step may be changed, some steps may be performed repeatedly, some steps may be omitted, or some steps may be added.

The above-described method may be provided as a computer program stored in a computer-readable recording medium for execution on a computer. The medium may continue to store a program executable by a computer, or may temporarily store it for execution or download. In addition, the medium may be various recording means or storage means in a form in which single or several hardwares are combined, and is not limited to a medium directly connected to a certain computer system, but may exist distributed on a network. Examples of the medium may include magnetic media such as a hard disk, a floppy disk, and a magnetic tape, optical recording media such as a CD-ROM and a DVD, magneto-optical media such as a floptical disk, and those configured to store program instructions, including ROM, RAM, flash memory, and the like. In addition, examples of other media include recording media or storage media managed by an app store that distributes applications or sites, servers, etc. that supply or distribute various other software.

The methods, operations, or techniques of the present disclosure may be implemented by various means. For example, these techniques may be implemented in hardware, firmware, software, or a combination thereof. Those skilled in the art will understand that various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the specific application and design requirements imposed on the overall system. Those skilled in the art may implement the described functionality in varying ways for each specific application, but such implementations should not be interpreted as causing a departure from the scope of the present disclosure.

In a hardware implementation, the processing units used to perform the techniques may be implemented within one or more ASICs, DSPs, digital signal processing devices (DSPDs), programmable logic devices (PLDs), field-programmable gate arrays (FPGAs), processors, controllers, microcontrollers, microprocessors, electronic devices, other electronic units designed to perform the functions described in the present disclosure, a computer, or a combination thereof.

Accordingly, various illustrative logic blocks, modules, and circuits described in connection with the present disclosure may be implemented or performed by a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other combination of configurations.

In a firmware and/or software implementation, the techniques may be implemented as instructions stored on a computer-readable medium such as random access memory (RAM), read-only memory (ROM), non-volatile random access memory (NVRAM), programmable read-only memory (PROM), erasable programmable read-only memory (EPROM), electrically erasable PROM (EEPROM), flash memory, a compact disc (CD), a magnetic or optical data storage device, and the like. The instructions may be executable by one or more processors and may cause the processor(s) to perform specific aspects of the functionality described in the present disclosure.

If implemented in software, the techniques described above may be stored as one or more instructions or code on a computer-readable medium or transmitted through a computer-readable medium. Computer-readable media include both computer storage media and communication media including any medium that facilitates transfer of a computer program from one place to another. Storage media may be any available media that can be accessed by a computer. By way of non-limiting example, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium.

For example, if software is transmitted from a website, server, or other remote source using coaxial cable, fiber optic cable, twisted pair, digital subscriber line (DSL), or wireless technologies such as infrared, radio, and microwave, then the coaxial cable, fiber optic cable, twisted pair, digital subscriber line, or wireless technologies such as infrared, radio, and microwave are included within the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above should also be included within the scope of computer-readable media.

A software module may reside in RAM memory, flash memory, ROM memory, EPROM memory, EEPROM memory, registers, a hard disk, a removable disk, a CD-ROM, or any other form of storage medium known in the art. An exemplary storage medium can be coupled to a processor such that the processor can read information from, or write information to, the storage medium. In the alternative, the storage medium may be integrated into the processor. The processor and the storage medium may reside in an ASIC. The ASIC may reside in a user terminal. In the alternative, the processor and the storage medium may reside as discrete components in a user terminal.

Although the embodiments described above have been described as utilizing aspects of the currently disclosed subject matter in one or more standalone computer systems, the present disclosure is not limited thereto and may be implemented in connection with any computing environment such as a network or distributed computing environment. Furthermore, aspects of the subject matter in the present disclosure may be implemented in a plurality of processing chips or devices, and storage may be similarly affected across a plurality of devices. Such devices may include PCs, network servers, and handheld devices.

Although the present disclosure has been described in connection with some embodiments in the present specification, various modifications and changes can be made without departing from the scope of the present disclosure that can be understood by those of ordinary skill in the art to which the invention of the present disclosure pertains. In addition, such modifications and changes should be considered to fall within the scope of the patent claims attached to the present specification.

1. An electronic device comprising:
an immutable memory; and
a security processor,
wherein the security processor is configured to:
obtain first authentication information of a host device from the host device using a security protocol if first authentication for the electronic device is successful by the host device connected through an interface,
register the first authentication information in the immutable memory,
perform second authentication for the host device based on the registered first authentication information,
create a first secure session using the security protocol if the second authentication is successful,
perform a first configuration for security of the interface through the first secure session,
obtain reference information including a configuration related to security of the host device from the host device using the security protocol,
register the reference information in the immutable memory, and
verify a security state of the host device based on the registered reference information.

2. (canceled)

3. The electronic device as claimed in claim 1, wherein the security processor is configured to:
if second authentication information of the host device is obtained from the host device using the security protocol, perform third authentication for the host device associated with the second authentication information based on the registered first authentication information,
register the second authentication information in the immutable memory if the third authentication is successful,
create a second secure session using the security protocol, and
perform a second configuration for security of the interface through the second secure session.

4. The electronic device as claimed in claim 2, wherein the security processor is configured to:
if third authentication information of the host device is obtained from the host device using the security protocol, perform fourth authentication for the host device associated with the third authentication information based on the registered first authentication information or the registered second authentication information,
register the third authentication information in the immutable memory if the fourth authentication is successful,
create a third secure session using the security protocol, and
perform a third configuration for security of the interface through the third secure session.

5. The electronic device as claimed in claim 2, wherein the security processor is configured to:
if a signal requesting revocation of the second authentication information is received from the host device using the security protocol, perform fourth authentication for the host device associated with the second authentication information based on the registered first authentication information, and
revoke the second authentication information from the immutable memory if the fourth authentication is successful.

6. The electronic device as claimed in claim 4, wherein the immutable memory comprises a plurality of slots for registering authentication information, a first field indicating whether authentication information is in a registered state in each of the plurality of slots, and a second field indicating whether authentication information registered in each of the plurality of slots is in a revoked state.

7. The electronic device as claimed in claim 2, wherein the second authentication information comprises authentication information associated with a trusted execution environment virtual machine (TEE VM) generated by the host device.

8. The electronic device as claimed in claim 1, wherein the security processor is configured to:
store mapping information of the first authentication information and information associated with the first configuration in a volatile memory accessible by the security processor, and
restrict a change of the information associated with the first configuration through other authentication information of the host device based on the mapping information.

9. The electronic device as claimed in claim 1, wherein the security protocol comprises a protocol based on security protocol and data model (SPDM).

10. The electronic device as claimed in claim 1, wherein the interface comprises a peripheral component interconnect express (PCIe) interface, and
the first configuration comprises a configuration associated with at least one of integrity and data encryption (IDE) or TEE device interface security protocol (TDISP).

11. A method for performing mutual authentication, performed by a security processor of an electronic device, the method comprising:
obtaining first authentication information of a host device from the host device using a security protocol if first authentication for the electronic device is successful by the host device connected through an interface;
registering the first authentication information in an immutable memory of the electronic device;
performing second authentication for the host device based on the registered first authentication information;
creating a first secure session using the security protocol if the second authentication is successful;
performing a first configuration for security of the interface through the first secure session;
obtaining reference information including a configuration related to security of the host device from the host device using the security protocol;
registering the reference information in the immutable memory; and
verifying a security state of the host device based on the registered reference information.

12. (canceled)

13. The method as claimed in claim 10, further comprising:
if second authentication information of the host device is obtained from the host device using the security protocol, performing third authentication for the host device associated with the second authentication information based on the registered first authentication information;
registering the second authentication information in the immutable memory if the third authentication is successful;
creating a second secure session using the security protocol; and
performing a second configuration for security of the interface through the second secure session.

14. The method as claimed in claim 11, further comprising:
if third authentication information of the host device is obtained from the host device using the security protocol, performing fourth authentication for the host device associated with the third authentication information based on the registered first authentication information or the registered second authentication information;
registering the third authentication information in the immutable memory if the fourth authentication is successful;
creating a third secure session using the security protocol; and
performing a third configuration for security of the interface through the third secure session.

15. The method as claimed in claim 11, further comprising:
if a signal requesting revocation of the second authentication information is received from the host device using the security protocol, performing fourth authentication for the host device associated with the second authentication information based on the registered first authentication information; and
revoking the second authentication information from the immutable memory if the fourth authentication is successful.

16. The method as claimed in claim 13, wherein the immutable memory comprises a plurality of slots for registering authentication information, a first field indicating whether authentication information is in a registered state in each of the plurality of slots, and a second field indicating whether authentication information registered in each of the plurality of slots is in a revoked state.

17. The method as claimed in claim 11, wherein the second authentication information comprises authentication information associated with a trusted execution environment virtual machine (TEE VM) generated by the host device.

18. The method as claimed in claim 10, further comprising:
storing mapping information of the first authentication information and information associated with the first configuration in a volatile memory accessible by the security processor; and
restricting a change of the information associated with the first configuration through other authentication information of the host device based on the mapping information.

19. The method as claimed in claim 10, wherein the security protocol comprises a protocol based on security protocol and data model (SPDM).

20. The method as claimed in claim 10, wherein the interface comprises a peripheral component interconnect express (PCIe) interface, and
the first configuration comprises a configuration associated with at least one of integrity and data encryption (IDE) or TEE device interface security protocol (TDISP).
